(19) United States
(12) Patent Application Publication
(10) Pub. No.: US 2010/0157829 A1
(43) Pub. Date: Jun. 24, 2010

(54) METHOD AND A DEVICE FOR IMPROVED CHANNEL QUALITY REPORTING

(75) Inventors: Anders Jonsson, Taby (SE); Kobe Sabbe, Stockholm (SE); Fredrik Ovesjo, Alvsjo (SE)

Correspondence Address: HARRITY & HARRITY, LLP, 11350 RANDOM HILLS RD., SUITE 600, FAIRFAX, VA, 22030, US

(73) Assignee: TELEFONAKTIEBOLAGET LM ERICSSON (PUBL), Stockholm (SE)

(21) Appl. No.: 12/601,091

(22) PCT Filed: May 24, 2007
(86) PCT No.: PCT/SE07/50357

§ 371 Date: Nov. 20, 2009

(51) Int. Cl. H04B 17/00; H04L 12/26

(52) U.S. Cl. 370/252; 455/67.11

(57) ABSTRACT

The invention discloses a method (200) for a wireless communications network (100) with a number of user terminals (130) and a first node (120) to which user terminals report a quality indicator value indicating the quality communication between the user terminal and the first node. The method (200) comprises using the reported quality indicator value from a user terminal to arrive at an adjusted quality indicator value for the user terminal, and also comprises obtaining the adjusted quality indicator value by comparing a reported quality indicator value with an expected quality indicator value, and an offset value is used to adjust the reported quality indicator value. The offset value is obtained as a result of the comparison, and the method (200) also comprises the step (250) of using the quality indicator value for adjusting the communication between the first node and the terminal.

### TECHNICAL FIELD

The present invention discloses a method and a device by means of which improved channel quality estimate can be obtained in wireless access communication systems.

### BACKGROUND

In many wireless access telecommunications systems, the user terminals report a quality indicator value which is indicative of the quality of a communications channel between the user terminal and another node in the system, usually a base station.

The quality indicator value is then used by the system in order to adjust the communication between the system and the reporting terminal. For example, in the WCDMA system, the user terminals, UEs, report the so called CQI, Channel Quality Indicator, to their Radio Base Stations, RBSs. The RBS then uses the CQI from each reporting UE in order to, for example, select UEs for scheduling, to determine the output power to use and to select the transport block, TB, size.

If the quality indicator value has a high quality, i.e. if the report from the UE is accurate and reliable, then the risk that the RBS schedules the wrong user, selects the wrong TB size or makes an erroneous output power allocation can be minimized.

As can be understood, the quality and reliability of the reported quality indicator value is of major importance in order to obtain the desired Block Error Rate, BLER, and the desired throughput of the system.

There are known methods of improving the quality indicator values and making them more “robust”. Among these methods, one which can be mentioned is to use uplink ACK/NACK information sent by the user terminals.

However, this solution cannot completely correct errors due to, for example, fast fading which will occur due to the difference in channel conditions caused by the delay between the point in time that the terminal measures the channel conditions and the actual channel conditions at the time of transmission.

Such a delay will, as a minimum, comprise the sum of the time required for the uplink transmission from the user terminal, the processing in the node that receives the report, and the downlink transmission from the system, usually the RBS, to the user terminal.

However, there may also be an additional delay to the minimum delay which is governed by the quality indicator value feedback cycle from the user terminal. This feedback cycle can in some systems be set by the network through higher layer signaling so that the user terminal does not report a quality indicator value to the system/the RBS every transmission time interval, TTI, meaning that there will be an additional delay.

Due to the interference caused by frequent reporting, it may be assumed that the reporting interval will be less frequent than every TTI in a multi-user scenario. Thus, even if a bias exhibited by a user terminal is corrected by a mechanism or algorithm, for example in the RBS, there will still be a residual error due to the delay mentioned above, which will affect the BLER and the system throughput in a negative way.

### SUMMARY

Thus, as has been explained above, there exists a need for a mechanism by means of which the channel quality indicator reported by a user terminal in a wireless access communication system such as a cellular telephony system may be improved upon.

This need is addressed by the present invention in that it provides a method for use in a wireless access communications network, in which network there can be a number of user terminals and a first node to which a user terminal reports a quality indicator value indicative of the quality of a communications channel between the user terminal and the first node.

The method of the invention comprises the step of using the reported quality indicator value from a user terminal in order to arrive at an adjusted quality indicator value for the user terminal in question, and the adjusted quality indicator value is obtained by means of comparing the quality indicator value reported by the terminal with an expected quality indicator value.

In addition, the method comprises the use of an offset value by means of which the quality indicator value reported by the terminal is adjusted. The offset value is obtained as a result of the comparison, and the method of the invention also comprises the step of using the adjusted quality indicator value for adjusting the communication between the first node and the terminal in question.

Suitably, in a preferred embodiment of the invention, the offset value is negative if the quality indicator value which is reported is larger than expected, and positive if the quality indicator value which is reported is smaller than expected.

Thus, by means of the present invention, the impact of variations in a channel quality indicator which are not actually caused by variations in the channel quality may be reduced, and in some cases even totally eliminated.

This, as well as other advantages of the present invention, will be understood even more clearly by means of the following detailed description.

### BRIEF DESCRIPTION OF THE DRAWINGS

The invention will be described in more detail in the following with reference to the appended drawings, in which

FIG. 1 shows an overview of a system in which the invention may be applied, and

FIG. 2 shows a flow chart of a method of the invention, and

FIG. 3 shows a block diagram of a transponder of the invention.

### DETAILED DESCRIPTION

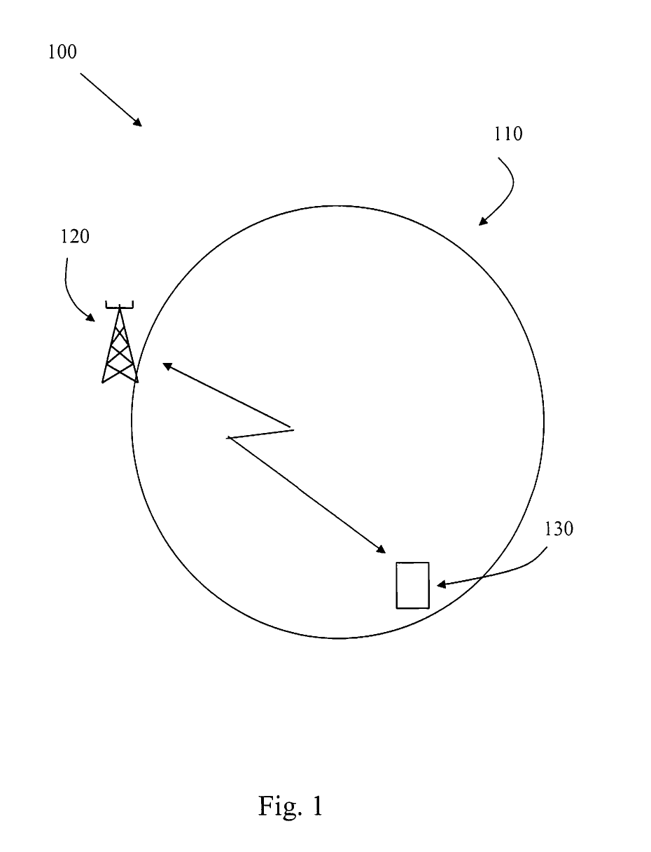

FIG. 1 shows an example of a system 100 in which the invention may be applied. The invention will, in order to facilitate the reader's understanding of the invention, be described with reference to a WCDMA system, but it should be pointed out that this is by way of example only, the invention can be applied in a wide range of wireless access communications systems, such as, for example, GSM and CDMA 2000. The invention is applicable to systems which utilize the principle of “channel quality reporting”, as will be explained below.

Thus, although the terminology used below in order to describe the invention may in some cases be specific for a WCDMA system, it will be realized that the same or corresponding system components will be found in other systems, albeit under other names. Thus, the terminology used below should be seen as specific instances of generic components in a system in which the invention may be applied

The system 100 in FIG. 1 is one in which there are a number of cells, one of which is shown and referenced as 110. In each cell there can be a number of users with user terminals, UEs, 130. The communication to and from the UEs in the system 100 is controlled by a Radio Base Station, RBS, 120.

In order for the RBS 120 to properly control and schedule the communication with the UEs 130 in the cell 110, the UEs at defined intervals report the quality of the communication from the RBS to the UE, said reports being sent from the UEs to the RBS as a channel quality indicator value, in the WCDMA system known as the CQI, Channel Quality Indicator. The CQI in WCDMA can be a value in the range of 0-30, with 30 indicating excellent channel quality, and 0 indicating no communication.

The CQI is used by the RBS 120, in order to, inter alia, schedule the different UE's in the cell for traffic, to select the output power for transmissions, and to select the size of the transport blocks, TB, sent to the UEs. As will thus be realized], an incorrect CQI can have a seriously negative impact on the performance of the system 100.

Several factors may determine the reported CQI values from the UEs, such as, for example, the UE's position in the cell, which may cause shadow fading and path loss. Examples of other factors which may influence the reported CQI from the UEs and which may be mentioned are:
the interference at the UE,
the radio environment: single-ray channel or multi-ray channel, Rayleigh or Ricean distributed fading, UE speed of motion etc,
the UE's algorithm for determining the CQI values,
the power offset variable known as Γ in the WCDMA system,
the power assigned to the CPICH, estimation errors etc.

As can be seen, a number of factors may thus influence a reported CQI.

It can be expected that the CQI reports from the UEs 130 will have a Gaussian-shaped distribution around a mean value, since many random factors are added to each other here. Further, since some of the above mentioned factors, such as for example e.g. path loss, vary on a slow basis, and some factors will vary on a faster basis, e.g. Rayleigh fading, it may be assumed that the channel quality will have a rather slowly varying expected value, such as a mean or average value, around which there will be a short-term value which will have a more rapidly varying distribution.

Also, since the CQI at the time of measurement/calculation by a UE will retain a certain level of correlation to previously reported CQIs from that UE, a prediction of the actual channel quality may be carried out in the RBS, based upon previously reported CQIs from one and the same UE.

One idea behind the present invention is to utilize the characteristics of the CQI as described above, i.e. a slowly varying short-term expected value such as a mean or average value, and a faster variation around this expected value.

Using this idea, the present invention suggests an adjustment of a reported CQI value based on a comparison of the reported CQI value with the expected CQI value, in a manner which will be explained in more detail in the following.

The expected CQI value used by the present invention can be calculated in a number of ways, but in a preferred embodiment of the invention, an average of CQI values reported during a predetermined interval of time is used as the expected value. The time interval used may differ between different systems and different applications, but an example of a suitable value is in the range of 0.01 seconds to 0.4 seconds.

Other examples of how the expected value mentioned above may be arrived at include calculating a median value, a predicted value according to a predetermined prediction algorithm or a filtered value according to a predetermined filtering value.

Thus, according to the present invention, an expected value for the CQI is calculated or determined, based upon previously reported CQIs during a certain interval in time. A “new” CQI reported by a UE is compared to the expected value, and an “offset” value is obtained as a result of the comparison. The offset value is then used in order to adjust the “new” CQI value, and the adjusted CQI which is thus obtained may be used for adjustments of the communication between the RBS and the UE which has reported the CQI in question.

In a particular embodiment of the invention, the offset value is negative if the CQI value which is reported is larger than the expected value, and positive if the CQI value which is reported is smaller than expected.

Thus, a processing of the CQIs reported by an UE will be carried out, so that there is a calculation of an expected value, in the present example a mean value, and based on this value there will be a reduction of a reported CQI if the reported CQI is larger than the mean value, and likewise there will be an increase of the reported CQI if the CQI reported is below the mean value.

The amount of increase or decrease is here referred to as the “offset”. The offset value to be used according to the invention is possible to calculate in a number of ways. The rate of increase or decrease as a function of the deviation from the mean CQI is also possible to set by means of a number of different functions, such as, for example, polynomial expression, spline functions, stepwise, stepwise linear, or other such mathematical functions or approximations.

One example of an implementation of the above would be an offset variation of the form:

Offset=B(A−x)+C(A−x)²+D(A−x)³+E(A−x)⁴+ . . . +Z(A−x)ⁿ (1)

In equation (1) above, x is the reported CQI value, and the expected value, which can be exemplified by a mean value would be given by A with B, C, E and Z etc. being constants. The CQI reporting range is defined in the 3GPP standard, according to which a UE may report a CQI value x in the range of 0 to 30.

A special case of the polynomial expression of eq. (1) would be a linear variation where all terms including and larger than x² are deleted:

Offset=B(A−x) (2)

The expected value A, which can be exemplified by a mean value, is filtered using the CQI values reported by a UE, and is gradually refined and adjusted to compensate for changing channel quality conditions due to changes in, for example, UE position, UE speed of movement etc. One simple filtering method is to use the first reported CQI as the initial mean, and to then use the average of subsequently received CQI reports up to a predetermined number or during a predetermined interval in time, after which a running average filtering is applied to determine and “track” the mean value A.

The method of the invention is suitably applied in the RBS 120 of the system 100, but it is also possible to use the method of the invention in the UEs 130. The main difference would be that in the latter case, i.e. if the method is applied in the UE, the CQI value that would be reported from the UE to the RBS would be the adjusted CQI value, and the function for using the adjusted CQI would then be in the RBS and not in the UE, i.e. not in the same node as the rest of the function of the invention.

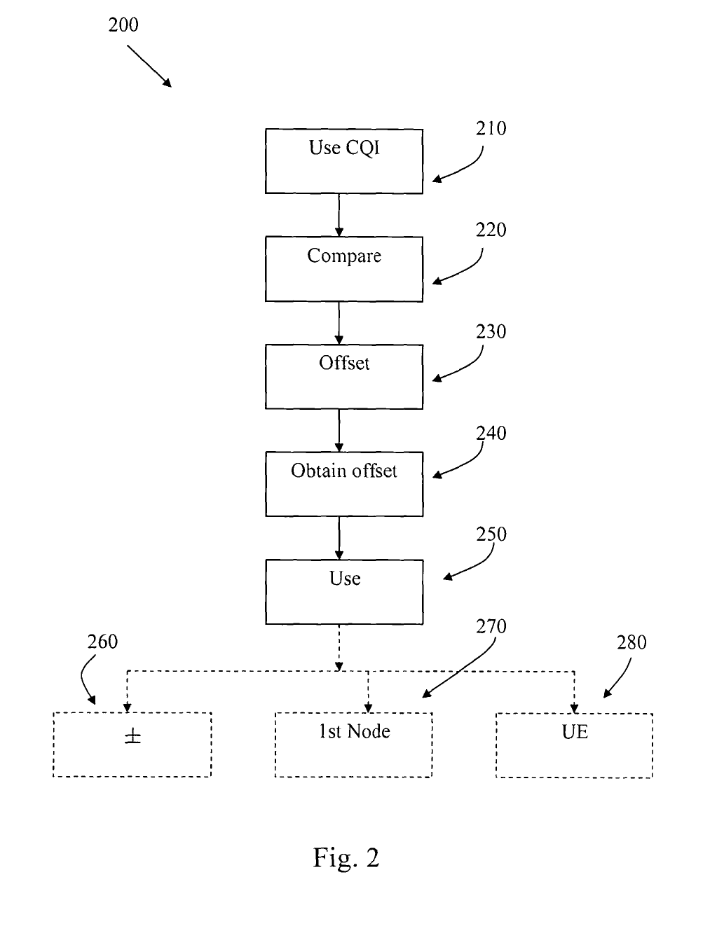

Turning now to FIG. 2, there is shown a flow chart of some of the steps of a method 200 of the invention. Steps which are options or alternatives are shown with dashed lines.

As shown in step 210 of the flowchart, the method 200 of the invention comprises the step of using a reported quality indicator value such as the CQI from a user terminal in order to arrive at an adjusted quality indicator value for the user terminal in question.

The method also comprises the step 220 of obtaining the adjusted quality indicator value by means of a comparison of the quality indicator value reported by a terminal with an expected quality indicator value, and the step 230 of using an offset value to adjust the reported quality indicator value.

Shown in step 240 is that the offset value is obtained as a result of the comparison, and step 250 shows that the method 200 also comprises the step of using said adjusted quality indicator value for adjustments of the communication between said first node and the terminal in question.

Step 260 shows that in a preferred embodiment of the invention, the offset value is negative if the quality indicator value or CQI which is reported from a UE is larger than the expected CQI value, and positive if the quality indicator value or CQI which is reported is smaller than the expected CQI value.

As shown in step 270, the adjusted quality indicator value of the method of the invention can be calculated in the RBS 120, so that the comparison (reported−expected CQI) is carried out and the offset value is calculated in the RBS, and the comparison and the offset value are used in the RBS to arrive at the adjusted quality indicator value, i.e. the adjusted CQI.

However, as also explained previously, and as shown in step 280 of the flowchart in FIG. 2, the adjusted quality indicator value or adjusted CQI may also be calculated in the reporting terminal, i.e. the comparison is carried out and the offset value is calculated in the UE, and the comparison and the offset value are used in the UE to arrive at the adjusted quality indicator value, which is then reported to the RBS.

In the latter case, the adjustments of the communication between the RBS and the UE are made in the RBS, on the basis of the reported adjusted CQI from the UE.

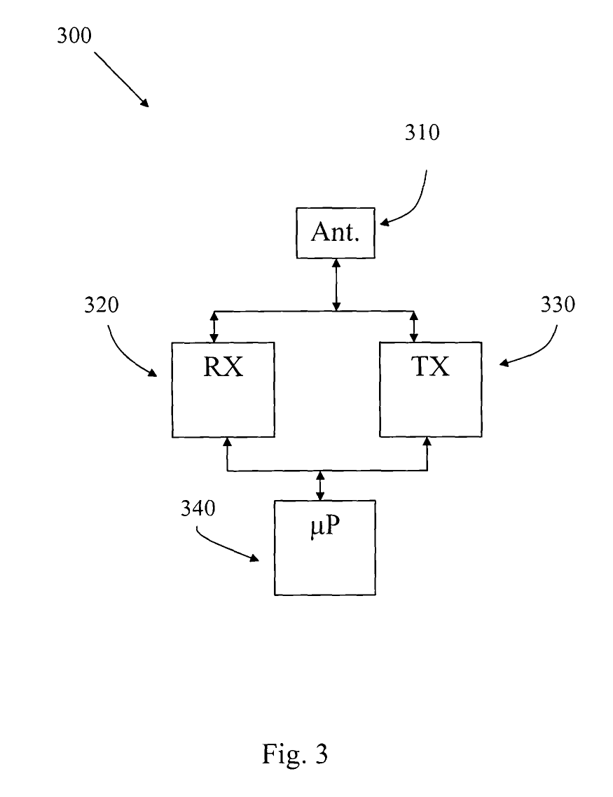

As mentioned above, the function discloses by the present invention may be carried out either in the RBS 120 or in the UE 130. Thus, FIG. 3 shows a block diagram of a generic transponder 300 according to the invention, which transponder 300 can be either an RBS or a UE in the system 100. As shown in FIG. 3, the transponder 300 comprises, inter alia, an antenna (“Ant.”) 310, a receiver (“Rx”) 320, a transmitter (“Tx”) 330 and computing means (“μP”) such as a microcomputer 340.

Accordingly, the transponder 300 comprises means for using a reported quality indicator value such as a CQI from a user terminal 130 in order to arrive at an adjusted CQI or quality indicator value for the user terminal in question, said means being the computer 340, and in the case where the transponder is the RBS, these means will also comprise the receiver 320 and the antenna 310.

The computer 340 serves as a means for obtaining the adjusted quality indicator value or CQI by comparing a quality indicator value reported by the terminal with an expected quality indicator value, and the computer 340 also serves as means for using an offset value to adjust the reported quality indicator value, as well as being a means for obtaining the offset value as a result of the comparison.

The invention is not limited to the examples of embodiments described above and shown in the drawings, but may be varied freely within the scope of the appended claims. For example, as has also been pointed out elsewhere in this text, the invention may be applied in a variety of systems which utilize the principle of channel quality reporting between two nodes in the system.

In addition, the present invention and its embodiments can be realised in many ways. For example, one embodiment of the present invention includes a computer-readable medium having instructions stored thereon that are executable by a computer system for obtaining improved channel quality estimate can be obtained in wireless access communication systems. The instructions executable by the computing system and stored on the computer-readable medium perform the method steps of the present invention as set forth in the claims.

Also, it should be pointed out that although the channel quality indicator of the invention has been exemplified above by means of the CQI in a WCDMA system, the invention may be applied to various kinds of systems in which a quality indicator value indicative of a channel quality is reported from one node in the system to another node in the system.

1. A method for use in a wireless access communications network, the wireless access communications network including a number of user terminals and a first node to which a user terminal reports a quality indicator value indicative of a quality of a communications channel between the user terminal and the first node, the method comprising:
using the reported quality indicator value from the user terminal in order to arrive at an adjusted quality indicator value for the user terminal, the adjusted quality indicator value being determined by comparing the quality indicator value reported by the user terminal with an expected quality indicator value to obtain an offset value, and using the offset value to adjust the reported quality indicator value, and
using said adjusted quality indicator value for adjustments of communication between said first node and the user terminal.

2. The method of claim 1, where the offset value is a negative value if the reported quality indicator value is larger than the expected quality indicator value, and a positive value if the reported quality indicator value is smaller than the expected quality indicator value.

3. The method of claim 1, where the adjusted quality indicator value is calculated in the first node.

4. The method of claim 1, where the adjusted quality indicator value is calculated in the user terminal and reported to the first node.

5. The method of claim 1, where the expected quality indicator value corresponds to a mean value of quality indicator values reported during a certain pre-determined interval of time.

6. The method of claim 5, where said interval of time is in a range of 0.01 seconds to 0.4 seconds.

7. The method of claim 1, where the wireless access communications network includes a Wideband Code Division Multiple Access (WCDMA) system, and
where the reported quality indicator value corresponds to a Channel Quality Indicator (CQI) in the WCDMA system.

8. A transponder for use in a wireless access communications network, the wireless access communications network including a number of user terminals and a first node to which a user terminal reports a quality indicator value indicative of a quality of a communications channel between the user terminal and the first node, the transponder comprising:
means for using the reported quality indicator value from the user terminal to obtain an adjusted quality indicator value for the user terminal, the means for using the reported quality indicator value comprising:
means for comparing the reported quality indicator value with an expected quality indicator value to obtain an offset value, and
means for using the offset value to adjust the reported quality indicator value; and
means for using the adjusted quality indicator value to adjust communication between the transponder and the user terminal.

9. The transponder of claim 8, where the offset value is a negative value if the reported quality indicator value is larger than the expected quality indicator value, and as a positive value if the reported quality indicator value is smaller than the expected quality indicator value.

10. The transponder of claim 8, where the expected quality indicator value is calculated as a mean value of quality indicator values reported during a certain pre-determined interval of time.

11. The transponder of claim 10, where said interval of time is in a range of 0.01 seconds to 0.4 seconds.

12. The transponder of claim 8, where said transponder corresponds to a Radio Base Station in said wireless access communications network.

13. The transponder of claim 8, where said transponder corresponds to the user terminal.

14. A computer-readable medium having instructions stored thereon which are executable by a computer system for performing a method, the method comprising:
using the reported quality indicator value from the user terminal in order to arrive at an adjusted quality indicator value for the user terminal, the adjusted quality indicator value being determined by comparing the quality indicator value reported by the user terminal with an expected quality indicator value to obtain an offset value, and using the offset value to adjust the reported quality indicator value; and
using said adjusted quality indicator value for adjustments of communication between said first node and the user terminal.

15. The computer-readable medium of claim 14, where the offset value is a negative value if the reported quality indicator value is larger than the expected quality indicator value, and a positive value if the reported quality indicator value is smaller than the expected quality indicator value.

16. Computer-readable medium of claim 14, where the adjusted quality indicator value is calculated in the first node.

17. Computer-readable medium of claim 14, where the adjusted quality indicator value is calculated in the user terminal and reported to the first node.

18. Computer-readable medium of claim 14, where the expected quality indicator value corresponds to a mean value of quality indicator values reported during a certain pre-determined interval of time.

19. Computer-readable medium of claim 18, where said interval of time is in a range of 0.01 seconds to 0.4 seconds
